(19) United States
(12) Patent Application Publication
(10) Pub. No.: US 2026/0249730 A1
(43) Pub. Date: Aug. 27, 2026

(54) Method of Design, Apparatus, Electronic Device, And Storage Medium For A Charging Station

(71) Applicants: STATE GRID JIANGSU ELECTRIC POWER CO., LTD. NANJING POWER SUPPLY BRANCH, Nanjing (CN); STATE GRID JIANGSU ELECTRIC POWER CO., LTD., Nanjing (CN); STATE GRID JIANGSU ELECTRIC POWER CO., LTD. SHUANGCHUANG CENTER, Nanjing (CN); NANJING SUYI INDUSTRIAL CO., LTD., Nanjing (CN)

(72) Inventors: Ye JI, Nanjing (CN); Weiya Zhang, Nanjing (CN); Hao Huang, Nanjing (CN); Wendi Wang, Nanjing (CN); Honghua Xu, Nanjing (CN); Gang Cao, Nanjing (CN); Qian Zhou, Nanjing (CN); Meilingzhi Chen, Nanjing (CN); Linglu Zhang, Nanjing (CN)

(21) Appl. No.: 19/379,136

(22) Filed: Nov. 4, 2025

(30) Foreign Application Priority Data
Feb. 14, 2025 (CN) 202510163301.4

(51) Int. Cl. B60L 53/62; B60L 53/65

(52) U.S. Cl. CPC B60L 53/62; B60L 53/65; B60L 2240/70

(57) ABSTRACT

A design method for a charging station includes determining at least one parameter value for each design parameter item according to an allowable design range and each design parameter item of the charging station, combining parameter values of each design parameter item to obtain at least one set of initial design data for the charging station; performing search optimization on at least one set of initial design data using design objectives of the charging station to obtain target design data; inputting each set of target design data into a pre-trained performance analysis model for performance analysis to obtain an actual performance analysis result corresponding to each set of target design data; generating and displaying a performance analysis report according to each set of target design data and the actual performance analysis result. The method shortens design cycle of a charging station and improves the overall efficiency.

### FIELD

The present invention relates to the field of computer technology, and in particular, to a design method, apparatus, electronic device, and storage medium for a charging station.

### BACKGROUND

This section provides background information related to the present disclosure which is not necessarily prior art.

With the rapid growth of the electric vehicle market, the demand for charging infrastructure has significantly increased. Therefore, the design and optimization of charging stations have become a major focus.

In the process of designing a charging station, it is necessary to consider meeting users’ charging needs, while ensuring the operational cost requirements and charging efficiency of the entire charging station. Therefore, designers usually need to combine all design parameter items of the charging station in sequence, and each parameter value of each design parameter item needs to be traversed. Only in this way can the optimal design data be selected for the construction of the charging station so as to both meet users’ charging needs and ensure low operating costs and high charging efficiency.

However, since there are many design parameter items for a charging station and each design parameter item contains multiple parameter values, the final combined design data will be extremely large in quantity. If each piece of design data is simulated, it will, to a certain extent, extend the design cycle of the charging station. Therefore, there is an urgent need to propose a new method to solve the above problem.

### SUMMARY

This section provides a general summary of the disclosure, and is not a comprehensive disclosure of its full scope or all of its features.

The present invention provides a design method, apparatus, electronic device, and storage medium for a charging station, solving the problem of long design cycle of the charging station rendered by the need of simulating each set of design data as there are many design data combinations, reducing invalid design data that do not match the design objectives or requirements of the current iteration, and improving the overall efficiency of the design cycle.

According to one aspect of the present invention, a design method for a charging station is provided, including:

determining at least one parameter value for each design parameter item according to an allowable design range and each design parameter item of the charging station, and combining parameter values of each design parameter item to obtain at least one set of initial design data for the charging station, wherein each set of initial design data includes one parameter value for each design parameter item;

performing search optimization on the at least one set of initial design data using design objectives of the charging station to obtain at least one set of target design data;

inputting each set of target design data into a pre-trained performance analysis model for performance analysis to obtain an actual performance analysis result corresponding to each set of target design data, wherein the performance analysis model is a model with a training design data as an input sample and a training performance analysis result corresponding to the training design data as an output; and

generating and displaying a performance analysis report according to each set of target design data and the actual performance analysis result corresponding to each set of target design data, for guiding a design strategy of the charging station.

Optionally, combining parameter values of each design parameter item to obtain at least one set of initial design data for the charging station includes:

determining a scanning strategy according to a preset parameter scanning type and a preset parameter distribution type; and scanning and combining the parameter values of each design parameter item according to the scanning strategy to obtain at least one set of initial design data for the charging station.

Optionally, performing search optimization on at least one set of initial design data using design objectives of the charging station to obtain at least one set of target design data includes:

inputting each set of initial design data into the performance analysis model for performance analysis to obtain an initial performance analysis result corresponding to each set of initial design data; determining an adaptability of each set of initial design data to the design objectives according to the design objectives of the charging station and the initial performance analysis result; performing a search in the initial design data using the adaptability of each set of initial design data to the design objectives to obtain an intermediate design data; and swapping part of the parameter values of identical design parameter items between any two intermediate design data to obtain the target design data.

Optionally, the process of training the performance analysis model includes:

determining a charging demand of a sample charging station according to vehicle arrival information of the sample charging station, and simulating the training design data using the charging demand as a simulation requirement scenario to obtain a label performance analysis result corresponding to the training design data, wherein the training design data includes a training sample set and a validation sample set; training an original model using the training sample set and validating the original model using the validation sample set, wherein the original model is an artificial neural network with at least two hidden layers; taking the original model as the performance analysis model if a difference between the training performance analysis result corresponding to the validation sample set output by the original model and the label performance analysis result is less than a preset threshold; and optimizing model parameters of the original model if the difference between the training performance analysis result corresponding to the validation sample set output by the original model and the label performance analysis result is greater than or equal to the preset threshold.

Optionally, determining a charging demand of a sample charging station according to vehicle arrival information of the sample charging station includes:

determining vehicle arrival information of at least one vehicle according to historical vehicle charging information of the sample charging station; determining an average vehicle arrival rate of the sample charging station according to the vehicle arrival information of at least one vehicle, and determining the charging demand according to the average vehicle arrival rate.

Optionally, determining the charging demand according to the average vehicle arrival rate includes:

determining battery charging information corresponding to at least one vehicle according to the historical vehicle charging information; calculating waiting time information and charging time information for each vehicle using the battery charging information of each vehicle and the average vehicle arrival rate; calculating a load curve of the sample charging station using the waiting time information, charging time information, and average vehicle arrival rate of vehicles, and taking the load curve as the charging demand.

Optionally, calculating waiting time information and charging time information for each vehicle using the battery charging information of each vehicle and the average vehicle arrival rate includes:

determining an initial sorting sequence for each vehicle according to the average vehicle arrival rate and the vehicle arrival information of each vehicle; determining a charging demand weight of each vehicle according to the initial sorting sequence of each vehicle and the battery charging information corresponding to the vehicle; determining a final sorting sequence of each vehicle according to the charging demand weight of each vehicle, and calculating the waiting time information and charging time information of each vehicle according to the final sorting sequence of each vehicle.

According to another aspect of the present invention, a design apparatus for a charging station is provided, including:

a combination module configured to determine at least one parameter value for each design parameter item according to an allowable design range and each design parameter item of the charging station, and combine parameter values of each design parameter item to obtain at least one set of initial design data for the charging station, wherein each set of initial design data includes one parameter value for each design parameter item;

an optimization module configured to perform search optimization on the at least one set of initial design data using design objectives of the charging station to obtain at least one set of target design data;

an analysis module configured to input each set of target design data into a pre-trained performance analysis model for performance analysis to obtain an actual performance analysis result corresponding to each set of target design data, wherein the performance analysis model is a model with a training design data as an input sample and a training performance analysis result corresponding to the training design data as an output; and

a display module configured to generate and display a performance analysis report according to each set of target design data and the actual performance analysis result corresponding to each set of target design data, for guiding a design strategy of the charging station.

Optionally, the apparatus further includes a model training module configured to train the performance analysis model. The model training module is configured to:

determine a charging demand of a sample charging station according to vehicle arrival information of the sample charging station, and simulate the training design data using the charging demand as a simulation requirement scenario to obtain a label performance analysis result corresponding to the training design data, wherein the training design data includes a training sample set and a validation sample set; train an original model using the training sample set and validate the original model using the validation sample set, wherein the original model is an artificial neural network with at least two hidden layers; take the original model as the performance analysis model if a difference between the training performance analysis result corresponding to the validation sample set output by the original model and the label performance analysis result is less than a preset threshold; and optimize model parameters of the original model if the difference between the training performance analysis result corresponding to the validation sample set output by the original model and the label performance analysis result is greater than or equal to the preset threshold.

Optionally, the model training module determining a charging demand of a sample charging station according to vehicle arrival information of the sample charging station includes:

determining vehicle arrival information of at least one vehicle according to historical vehicle charging information of the sample charging station; determining an average vehicle arrival rate of the sample charging station according to the vehicle arrival information of at least one vehicle, and determining the charging demand according to the average vehicle arrival rate.

Optionally, the model training module determining the charging demand according to the average vehicle arrival rate includes:

determining battery charging information corresponding to at least one vehicle according to the historical vehicle charging information; calculating waiting time information and charging time information for each vehicle using the battery charging information of each vehicle and the average vehicle arrival rate; calculating a load curve of the sample charging station using the waiting time information, charging time information, and average vehicle arrival rate of vehicles, and taking the load curve as the charging demand.

Optionally, the model training module calculating waiting time information and charging time information for each vehicle using the battery charging information of each vehicle and the average vehicle arrival rate includes:

determining an initial sorting sequence for each vehicle according to the average vehicle arrival rate and the vehicle arrival information of each vehicle; determining a charging demand weight of each vehicle according to the initial sorting sequence of each vehicle and the battery charging information corresponding to the vehicle; determining a final sorting sequence of each vehicle according to the charging demand weight of each vehicle, and calculating the waiting time information and charging time information of each vehicle according to the final sorting sequence of each vehicle.

According to a further aspect of the present invention, an electronic device is provided, comprising:

at least one processor; and

a memory communicatively connected to the at least one processor; wherein

the memory stores a computer program executable by the at least one processor, and the computer program, when executed by the at least one processor, causes the at least one processor to perform the design method for a charging station according to any embodiment of the present invention.

According to a still further aspect of the present invention, a computer-readable storage medium is provided, which stores computer instructions, wherein the computer instructions, when executed by a processor, implement the design method for a charging station according to any embodiment of the present invention.

According to the design method for a charging station provided in the embodiments of the present invention, at least one parameter value for each design parameter item is determined according to an allowable design range and each design parameter item of the charging station, and parameter values of each design parameter item are combined to obtain at least one set of initial design data for the charging station; search optimization is performed on the at least one set of initial design data using design objectives of the charging station to obtain at least one set of target design data; each set of target design data is input into a pre-trained performance analysis model for performance analysis to obtain an actual performance analysis result corresponding to each set of target design data; and a performance analysis report is generated and displayed according to each set of target design data and the actual performance analysis result corresponding to each set of target design data. On one hand, the method performs search optimization on initial design data, allowing the screening and obtaining of target design data that is closer to the objectives or requirements for the current charging station design from the initial design data, solving the problem that the design cycle of the charging station is long due to the need to simulate each set of design data when there are many design data combinations. This not only reduces invalid design data that do not match the objectives or requirements of the current design, improving the overall efficiency of the design cycle, but also enables rapid optimization of design data and provides more suitable design data for determining the design data later. On the other hand, analyzing the target design data using a performance analysis model to yield the actual performance analysis result corresponding to each set of target design data, enabling accurate and rapid simulation of the charging station design based on each set of target design data to obtain performance indicators for evaluating the target design data. At the same time, generating and displaying a performance analysis report based on each set of target design data and the corresponding actual performance analysis result provides users with multiple selectable and relatively optimal target design data, thereby meeting users’ design objectives and requirements while enhancing the user experience, and providing users with more options so that the final design of the charging station returns to being user-led.

It should be understood that the content described in this section is not intended to identify the key or essential features of the embodiments of the present invention, nor is it intended to limit the scope of the present invention. Other features of the present invention will become more apparent through the following description.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

In order to more clearly illustrate the technical solutions in the embodiments of the present invention, the drawings required in the description of the embodiments will be briefly introduced below. It is apparent that the drawings described below are merely some embodiments of the present invention, and for those of ordinary skill in the art, other drawings can also be obtained based on these drawings without any creative work.

FIG. 1 is a flowchart of a design method for a charging station provided in an embodiment of the present invention;

FIG. 2 is a flowchart of another design method for a charging station provided in an embodiment of the present invention;

FIG. 3 is an example diagram of a training process for a performance analysis model provided in an embodiment of the present invention;

FIG. 4 is a schematic structural diagram of a design apparatus for a charging station provided in an embodiment of the present invention;

FIG. 5 is a schematic structural diagram of an electronic device provided in an embodiment of the present invention.

Corresponding reference numerals indicate corresponding parts throughout the several views of the drawings.

### DETAILED DESCRIPTION

Example embodiments will now be described more fully with reference to the accompanying drawings.

To enable those skilled in the art to better understand the solutions of the present invention, the technical solutions in the embodiments of the present invention will be clearly and completely described below in conjunction with the drawings of the embodiments of the present invention. It is apparent that the described embodiments are only part of, rather than all of, the embodiments of the present invention. Based on the embodiments of the present invention, all other embodiments obtained by a person of ordinary skill in the art without creative work shall fall within the protection scope of the present invention.

It should be noted that, in the specification and claims of the present invention and in the above drawings, the terms “initial”, “target”, and the like are used to distinguish similar objects, rather than to describe a specific order or sequence. It should be understood that such data may be interchanged where appropriate, so that the embodiments of the present invention described herein can be implemented in sequences other than those illustrated or described herein. In addition, the terms “comprise” and “have” and any variations thereof are intended to cover a non-exclusive inclusion. For example, a process, method, system, product, or device that comprises a series of steps or units is not limited to only those steps or units clearly listed, but may include other steps or units not clearly listed or inherent to such processes, methods, products, or devices.

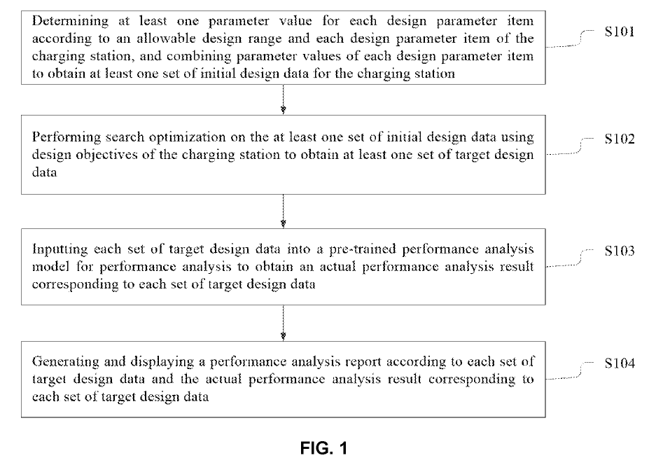

FIG. 1 is a flowchart of a design method for a charging station provided in an embodiment of the present invention. This embodiment can be applied to the case of quickly designing a low-cost charging station. The method can be executed by a design apparatus for a charging station. The design apparatus for a charging station can be implemented in the form of hardware and/or software and may be configured in an electronic device. In this embodiment, the electronic device may be a computer or a server.

As shown in FIG. 1, the method comprises:

S11, determining at least one parameter value for each design parameter item according to an allowable design range and each design parameter item of the charging station, and combining parameter values of each design parameter item to obtain at least one set of initial design data for the charging station.

Here, each set of initial design data includes one parameter value for each design parameter item. The allowable design range is a range of selectable parameter values for each design parameter item set by the user.

Specifically, the design parameter items of a charging station may include the number of modules, the power of each module, the number of charging piles, the number of charging blocks, and so on. Each design parameter item has a parameter value range. For example, the parameter value range for the number of charging piles may be 1 to 2. Based on this, the parameter value corresponding to each design parameter item can be determined within the limits of the allowable design range of the charging station, and the parameter values of each design parameter item can be combined to obtain at least one set of initial design data for the charging station.

By way of example, it is assumed that the parameter values for the number of modules are 2, 4, 6, 8, 1; and the parameter values for the number of charging piles are 1, 2, 3, 4, 5. The allowable design range restricts the number of modules to be less than or equal to 4, and the number of charging piles to be less than or equal to 3. Then, one set of initial design data (number of modules, number of charging piles) can be (2, 1), (2, 2), (2, 3), (4, 1), (4, 2), and (4, 3).

S12, performing search optimization on the at least one set of initial design data using design objectives of the charging station to obtain at least one set of target design data.

Specifically, since the requirements for designing different charging stations vary, the initial design data can be searched and optimized according to the objectives or requirements of the current charging station design after the initial design data are obtained, to obtain design data that are closer to the objectives or requirements of the current charging station design, namely the target design data. For example, search optimization can be performed on the initial design data using algorithms such as particle swarm optimization or genetic algorithms to obtain at least one set of target design data.

In this embodiment, performing search optimization on the initial design data allows for screening and obtaining target design data from the initial design data that are closer to the objectives or requirements of the current charging station design, thus solving the problem that the design cycle of the charging station is long due to the need to simulate each set of design data when there are many design data combinations. This not only reduces some invalid design data that do not match the objectives or requirements of the current design, improving the overall efficiency of the design cycle, but also enables rapid optimization of design data and provides design data that better meets target requirements for subsequent design data determination.

S13, inputting each set of target design data into a pre-trained performance analysis model for performance analysis to obtain an actual performance analysis result corresponding to each set of target design data.

Here, the performance analysis model is a model with a training design data as an input sample and a training performance analysis result corresponding to the training design data as an output. The actual performance analysis result is used to reflect the performance of the charging station designed using the target design data during actual operation after commissioning.

Specifically, each set of target design data can be input into the pre-trained performance analysis model. The performance analysis model will perform performance analysis on each set of target design data and output the actual performance analysis result corresponding to each set of target design data after the analysis. The actual performance analysis result includes performance evaluation indicators such as system time ratio, efficiency, and capital expenditure.

S14, generating and displaying a performance analysis report according to each set of target design data and the actual performance analysis result corresponding to each set of target design data.

Here, the performance analysis report is used to guide the design strategy of the charging station.

Specifically, since each set of target design data has a corresponding actual performance analysis result, in order to facilitate the user in selecting the required target design data, a performance analysis report containing each set of target design data and the corresponding actual performance analysis result can be generated and displayed to the user, so that the user can select a set of target design data required according to the actual performance analysis result of each set of target design data, thereby guiding the user in designing the charging station.

In this embodiment, by analyzing the target design data using the performance analysis model to obtain the actual performance analysis result corresponding to each set of target design data, the problem of inflexibility caused by relying solely on manual experience in the current charging station design is solved, achieving accurate and rapid simulation of the charging station design based on each set of target design data, and obtaining performance indicators for evaluating the target design data. At the same time, based on each set of target design data and its corresponding actual performance analysis result, a performance analysis report is generated and displayed, providing the user with multiple selectable and relatively optimal target design data, thereby meeting the user’s design objectives and requirements while enhancing the user experience, and providing the user with more options so that the final charging station design returns to being user-led.

According to the design method for a charging station provided in the embodiment of the present invention, at least one parameter value for each design parameter item is determined according to an allowable design range and each design parameter item of the charging station, and parameter values of each design parameter item are combined to obtain at least one set of initial design data for the charging station; search optimization is performed on the at least one set of initial design data using design objectives of the charging station to obtain at least one set of target design data; each set of target design data is input into a pre-trained performance analysis model for performance analysis to obtain an actual performance analysis result corresponding to each set of target design data; and a performance analysis report is generated and displayed according to each set of target design data and the actual performance analysis result corresponding to each set of target design data. In the above method, On one hand, search optimization on initial design data is performed, allowing the screening and obtaining of target design data that is closer to the objectives or requirements for the current charging station design from the initial design data, solving the problem that the design cycle of the charging station is long due to the need to simulate each set of design data when there are many design data combinations. This not only reduces invalid design data that do not match the objectives or requirements of the current design, improving the overall efficiency of the design cycle, but also enables rapid optimization of design data and provides more suitable design data for determining the design data later. On the other hand, analyzing the target design data using a performance analysis model to yield the actual performance analysis result corresponding to each set of target design data, enabling accurate and rapid simulation of the charging station design based on each set of target design data to obtain performance indicators for evaluating the target design data. At the same time, generating and displaying a performance analysis report based on each set of target design data and the corresponding actual performance analysis result provides users with multiple selectable and relatively optimal target design data, thereby meeting users’ design objectives and requirements while enhancing the user experience, and providing users with more options so that the final design of the charging station returns to being user-led.

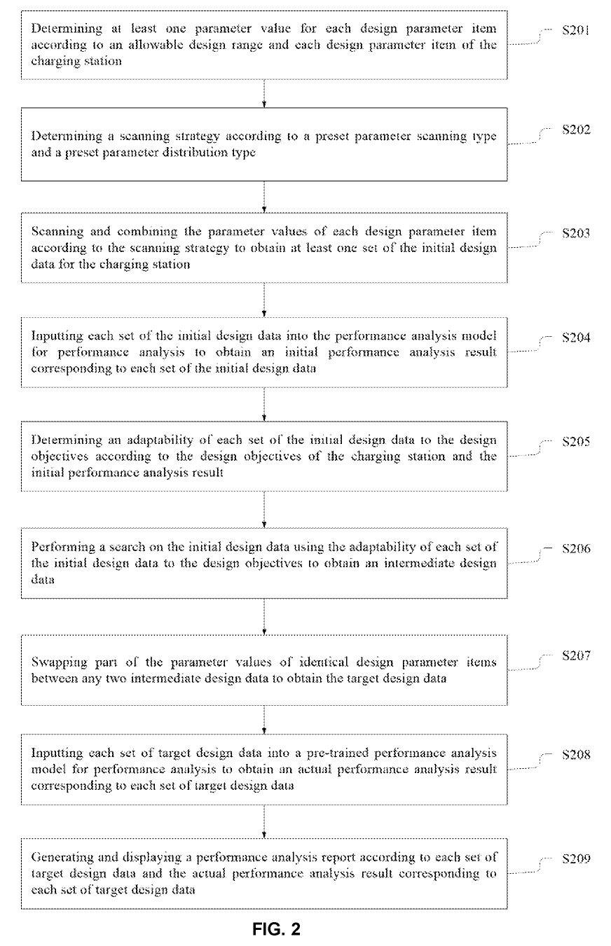

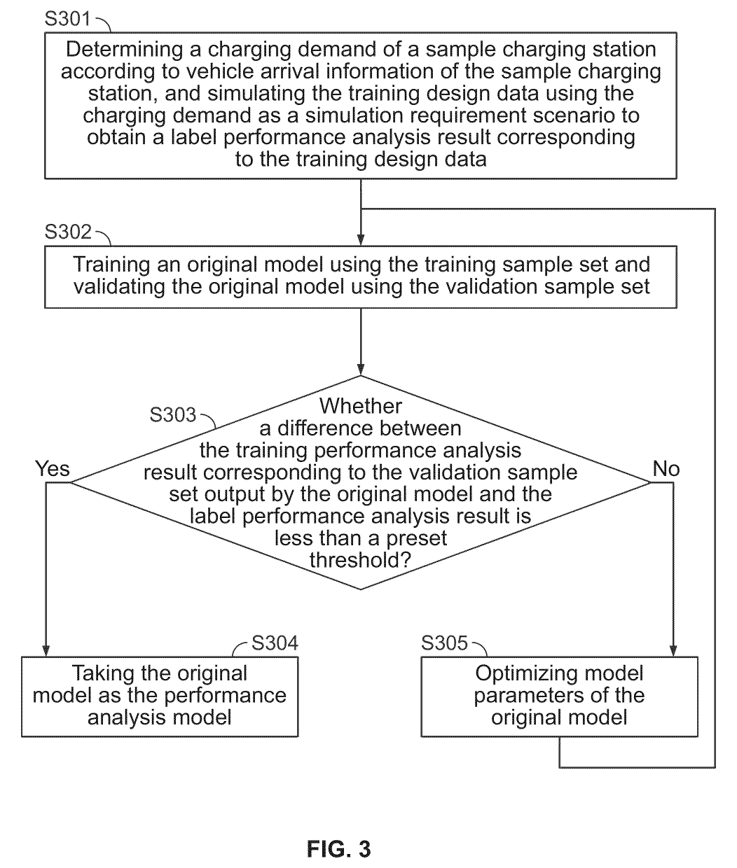

FIG. 2 is a flowchart of another design method for a charging station provided in an embodiment of the present invention. This embodiment, on the basis of the above embodiment, focuses on the steps of obtaining the initial design data and target design data. Before introducing FIG. 2, the training process of the performance analysis model provided in the embodiment of the present invention will be described in detail. FIG. 3 is an example diagram of the training process of the performance analysis model provided in an embodiment of the present invention, which includes the following steps:

S31, determining a charging demand of a sample charging station according to vehicle arrival information of the sample charging station, and simulating the training design data using the charging demand as a simulation requirement scenario to obtain a label performance analysis result corresponding to the training design data.

Here, the training design data includes a training sample set and a validation sample set. The vehicle arrival information is the time information when vehicles arrive at the sample charging station. The charging demand refers to the demand for charging different vehicles after arriving at the sample charging station.

The vehicle arrival information (arrival time) of one or more sample charging stations can be determined according to the historical vehicle arrival information of one or more sample charging stations and expected charging time information of vehicles. The process of each vehicle charging after arriving at the sample charging station can be simulated according to the vehicle arrival information. The simulated process can determine the charging demand of the sample charging station. The training design data can be obtained according to the method of S11, or according to the method of S11 to S12, or by using the Monte Carlo method to randomly sample the parameter values of each design parameter item. After obtaining the training design data, the training design data can be simulated with the charging demand as the simulation requirement scenario, and the performance analysis result obtained after simulation for each training design data can be taken as the label for that training design data.

By way of example, determining the charging demand of the sample charging station according to the vehicle arrival information of the sample charging station may include:

(1) determining vehicle arrival information of at least one vehicle according to historical vehicle charging information of the sample charging station.

Specifically, according to the historical vehicle charging information of the sample charging station, it can be determined, in the historical process, the vehicle arrival time at the sample charging station for each vehicle entering the sample charging station, namely the vehicle arrival information.

(2) determining an average vehicle arrival rate of the sample charging station according to the vehicle arrival information of at least one vehicle, and determining the charging demand according to the average vehicle arrival rate.

Specifically, the arrival times of each vehicle can be sorted according to the vehicle arrival information of at least one vehicle, and the average vehicle arrival rate of the sample charging station can be determined according to the vehicle arrival information. For example, the Poisson distribution formula can be used to calculate the average vehicle arrival rate.

By way of example, determining the charging demand according to the average vehicle arrival rate may include:

1) determining battery charging information corresponding to at least one vehicle according to the historical vehicle charging information.

Specifically, the historical vehicle charging information of the sample charging station not only records the arrival time of the vehicles that came to charge at the sample charging station in the historical process, i.e., the vehicle arrival information, but also records information such as the battery capacity, remaining battery power, and expected charging amount of each vehicle, i.e., the battery charging information. Therefore, the battery charging information corresponding to at least one vehicle that arrived at the sample charging station to charge in the historical process can be determined according to the historical vehicle charging information.

2) calculating the waiting time information and charging time information for each vehicle using the battery charging information of each vehicle and the average vehicle arrival rate.

Specifically, the waiting time information and charging time information for each vehicle can be calculated using the First-Come-First-Served (FCFS) strategy and the Supply Minimum strategy.

By way of example, the calculation can be carried out as follows:

(1) determining an initial sorting sequence for each vehicle according to the average vehicle arrival rate and the vehicle arrival information of each vehicle. Specifically, the average vehicle arrival rate can reflect the arrival situation of vehicles at the sample charging station during a certain period, while the vehicle arrival information can specify the time each vehicle arrives at the sample charging station. Therefore, the initial sorting of each vehicle’s arrival situation can first be performed based on the average vehicle arrival rate and the vehicle arrival information of each vehicle to obtain the initial sorting sequence.

For example, in the first cycle, according to the average vehicle arrival rate, it is determined that five vehicles arrive at the sample charging station. According to the vehicle arrival information of each vehicle, the arrival times of these five vehicles can be determined. At this time, these five vehicles can be sorted according to their arrival times to obtain the initial sorting sequence.

(2) determining the charging demand weight of each vehicle according to the initial sorting sequence of each vehicle and the battery charging information corresponding to that vehicle.

Specifically, since the initial sorting sequence obtained according to method (1) may have the case where multiple vehicles have exactly the same arrival time, i.e., the initial sorting sequences of the multiple vehicles may be in parallel, it is necessary to introduce the battery charging information corresponding to each vehicle to determine the current charging demand weight of each vehicle.

By way of example, the closer a vehicle is to the front of the initial sorting sequence, the higher its charging demand weight. In the battery charging information corresponding to the vehicle, for example, the smaller the remaining battery power of the vehicle, the higher its charging demand weight; the greater the battery capacity of the vehicle, the lower its charging demand weight; the smaller the expected charging amount, the higher its charging demand weight. The remaining battery power of the vehicle is the most important indicator, the initial sorting sequence is the second most important indicator, and the expected charging amount and the battery capacity of the vehicle can be allocated according to user requirements.

Based on the above method, the charging demand weight of each vehicle can first be determined according to the initial sorting sequence of each vehicle and the battery charging information corresponding to the vehicle.

(3) Determining a final sorting sequence of each vehicle according to the charging demand weight of each vehicle, and calculating the waiting time information and charging time information for each vehicle according to the final sorting sequence of each vehicle.

Specifically, after determining the charging demand weight of each vehicle, the final sorting sequence of each vehicle can be determined. That is, if each vehicle needs charging, charging can be performed on the vehicles in the order indicated by the final sorting sequence. Subsequently, according to the final sorting sequence of each vehicle, the waiting time and the charging time required for each vehicle to be charged, i.e., the waiting time information and charging time information of each vehicle, can be calculated.

In this embodiment, based on the average vehicle arrival rate, and the vehicle arrival information and battery charging information of each vehicle, it is possible to determine the waiting time and charging time each vehicle will require upon arriving at the sample charging station for charging. Based on the first-come-first-served principle and the minimum power supply principle, the charging demand weight of vehicles arriving at the sample charging station can be reasonably calculated to reflect the current degree of demand for charging each vehicle. The initial sorting sequence can be fine-tuned according to the degree of demand so that, during simulation, the sample charging station can meet the charging needs of each vehicle as much as possible while reducing the waiting time and charging time of each vehicle.

3) calculating a load curve of the sample charging station using the waiting time information, charging time information, and average vehicle arrival rate of the vehicles, and using the load curve as the charging demand.

Specifically, based on the obtained waiting time information, charging time information, and average vehicle arrival rate of the vehicles, the load curve of the sample charging station in each cycle can be calculated. The load curve is used to represent the load borne by the sample charging station in each cycle to provide charging demand for arriving vehicles. Therefore, the load curve can be used as the charging demand. In the load curve, the charging demand of the sample charging station in each cycle (each hour) can be clearly shown. Optionally, the load curve may be a daily load curve.

In this embodiment, based on the vehicle arrival rate at the sample charging station, and the waiting time and charging time required for vehicle charging, the load curve of the sample charging station in each cycle can be determined, and the load curve can be used as the charging demand of the sample charging station, thereby realizing a simulation of the load situation of the sample charging station in the historical process. The simulation result is taken as the charging demand of the sample charging station, providing an important basis for using this charging demand as the demand of the charging station currently in the design process, so as to realize simulation of the training design data under the scenario where this charging demand is used as the simulation requirement, obtain an accurate label performance analysis result corresponding to the training design data, and provide labels for sample data for subsequent training of the performance analysis model.

S32, training an original model using the training sample set, and validating the original model using the validation sample set.

Specifically, before training the original model, the training design data can be divided into a training sample set and a validation sample set. When training the original model, the training sample set can be used to train the original model, and after training is completed, the validation sample set can be used to validate the training result of the original model.

S33, determining whether the difference between the training performance analysis result corresponding to the validation sample set output by the original model and the label performance analysis result is less than a preset threshold; if yes, S34 is performed; if no, S35 is performed.

Specifically, after training the original model using the training sample set, the samples in the validation sample set are input into the original model, and the original model outputs the training performance analysis result corresponding to the validation sample set. At this time, the training performance analysis result can be compared with the label performance analysis result to determine the difference therebetween. If the difference therebetween is less than the preset threshold, it means that the training of the original model has met the user’s requirements, and S34 can be directly executed. If the difference therebetween is greater than or equal to the preset threshold, it means that the training of the original model has not met the user’s requirements, and S35 needs to be executed.

S34, using the original model as the performance analysis model.

Specifically, if the difference between the training performance analysis result and the label performance analysis result is less than the preset threshold, the original model can be directly used as the performance analysis model. At this time, the input of the performance analysis model is the design data (such as module quantity, module power, number of charging piles, etc.), and the output is the performance analysis result (the performance analysis result includes performance indicators such as charging efficiency, cost-effectiveness ratio, waiting time, etc.).

S35, optimizing model parameters of the original model.

Specifically, if the difference between the training performance analysis result and the label performance analysis result is greater than or equal to the preset threshold, it is necessary to re-optimize the model parameters of the original model and retrain the original model until the difference between the training performance analysis result and the label performance analysis result is less than the preset threshold.

Following the introduction of the training process of the performance analysis model shown in FIG. 3, reference is made again to FIG. 2.

As shown in FIG. 2, the method includes:

S21, determining at least one parameter value for each design parameter item according to the allowable design range and each design parameter item of the charging station.

Specifically, the allowable design range of the charging station can be used as a constraint to determine a parameter value corresponding to each design parameter item.

S22, determining a scanning strategy according to a preset parameter scanning type and a preset parameter distribution type.

Specifically, parameters are scanned, and the parameter scanning type can be divided into full parameter scanning or partial scanning. Full parameter scanning is to combine all possible values of each parameter with all possible values of other parameters. Partial scanning is to select only a few representative values within the parameter range. The parameter distribution type is classified into uniform distribution or non-uniform distribution. Uniform distribution refers to evenly spaced parameter distribution. Non-uniform distribution refers to parameter distribution that needs to be adjusted according to key inspection areas. The parameter distribution type can be determined according to the user’s preset settings. After selecting the parameter scanning type and parameter distribution type, the scanning strategy for parameter scanning can be determined.

S23, scanning and combining the parameter values of each design parameter item according to the scanning strategy to obtain at least one set of the initial design data for the charging station.

In one implementation, in the case of the full parameter scanning, a list of values can be created for each parameter, and then the Cartesian product can be used to generate all possible parameter combinations, that is, combining the parameter values of each design parameter item to obtain all combination data as the initial design data. In another implementation, representative values are selected to generate parameter combinations, that is, combining partial parameter values of partial design parameter items to obtain data as the initial design data.

S24, inputting each set of initial design data into the performance analysis model for performance analysis to obtain an initial performance analysis result corresponding to each set of initial design data.

Specifically, each set of initial design data is input into the performance analysis model, which analyzes it to obtain the initial performance analysis result corresponding to the initial design data.

S25, determining an adaptability of each set of initial design data to the design objectives according to the design objectives of the charging station and the initial performance analysis result.

Here, the design objectives are the design requirements for the charging station when the user designs the charging station. For example, if the user needs to design a charging station with high efficiency and low cost, then high efficiency and low cost are the design objectives.

Specifically, each set of initial design data has a corresponding initial performance analysis result, so the similarity or matching degree between the initial performance analysis result corresponding to each set of initial design data and the design objectives can be calculated, and can be used as the adaptability to the design objectives.

In one implementation, in the case of the full parameter scanning, the different performance analysis results corresponding to all design parameter items under different parameter value combinations, as well as the adaptability to the design objectives, can be obtained. Based on this, it can be known how the changes in each parameter value affect the final performance of the charging station. In another implementation, in the case of the partial parameter scanning, the different performance analysis results corresponding to different parameter items under different parameter value combinations, as well as the adaptability to the design objectives, can be obtained. Based on this, it can be known which parameter item will affect the final performance of the charging station under different parameter item combinations.

In this embodiment, determining the adaptability of each set of initial design data to the design objectives according to the design objectives of the charging station and the initial performance analysis result can quantify, through the adaptability, the closeness of the final performance indicators of the charging station designed by simulation using different initial design data to the design objectives. The adaptability can be used to determine the importance of different design parameter items or different parameter values to the design objectives, providing important support for selecting the target design data later.

S26, searching the initial design data using the adaptability of each set of initial design data to the design objectives to obtain an intermediate design data.

Specifically, the intermediate design data can be determined by searching the initial design data based on each set of initial design data and the adaptability to the design objectives.

In one implementation, in the case of the full parameter scanning, the parameter item whose parameter value has a greater impact on efficiency and cost in the performance of the charging station can be determined based on the adaptability to the design objectives. For example, the parameter item is the number of modules. If a larger number of modules results in a higher efficiency of the designed charging station, the parameter item corresponding to a parameter value with a larger number of modules can be selected. If, when the module power is higher, a smaller number of modules can also ensure high efficiency and low cost of the designed charging station, the initial design data including the parameter item corresponding to a parameter value with a moderate number of modules and a larger module power can be selected as the intermediate design data.

In another implementation, in the case of the partial parameter scanning, the parameter item that has a greater impact on the designed charging station can be directly determined according to the parameter items included in the initial design data. For example, if the initial design data includes module power, it will, to a certain extent, result in a designed charging station with high efficiency and low cost, and the initial design data including the parameter item of module power can be taken as the intermediate design data.

S27, swapping part of the parameter values of identical design parameter items between any two intermediate design data to obtain the target design data.

Specifically, in order to ensure that the finally obtained target design data is diverse, and that the performance of the charging station finally designed based on the design data is closer to the design objectives, part of the parameter values of identical design parameter items between any two intermediate design data can be swapped to obtain the target design data.

For example, it is assumed that there are two intermediate design data A: [number of modules 6, number of charging piles 1], and intermediate design data B: [number of modules 8, number of charging piles 6], then the obtained target design data can be: [number of modules 8, number of charging piles 1], [number of modules 6, number of charging piles 6]. If computing power is sufficient, the intermediate design data can also be directly used as the target design data, that is, the final target design data obtained are [number of modules 8, number of charging piles 1], [number of modules 6, number of charging piles 6], [number of modules 6, number of charging piles 1], and [number of modules 8, number of charging piles 6].

In this embodiment, each set of initial design data is searched to obtain the intermediate design data, and the intermediate design data is optimized to obtain the target design data. This not only achieves the screening of the initial design data, selecting from them those design data whose performance for the charging station is closer to the design target parameter items as the target design data, but also optimizes the target parameter items so that the target design data has diversity.

S28, inputting each set of target design data into the pre-trained performance analysis model for performance analysis, to obtain an actual performance analysis result corresponding to each set of target design data.

Specifically, each set of target design data may be input into the pre-trained performance analysis model. The performance analysis model will perform performance analysis on each set of target design data and output the actual performance analysis result corresponding to each set of target design data after the analysis.

S29, generating and displaying a performance analysis report according to each set of target design data and the actual performance analysis result corresponding to each set of target design data.

Specifically, a performance analysis report containing each set of target design data and the actual performance analysis result corresponding to each set of target design data may be generated and displayed to the user, so that the user can select a set of target design data required by the user according to the actual performance analysis result of each set of target design data, thereby achieving the purpose of guiding the user to design the charging station.

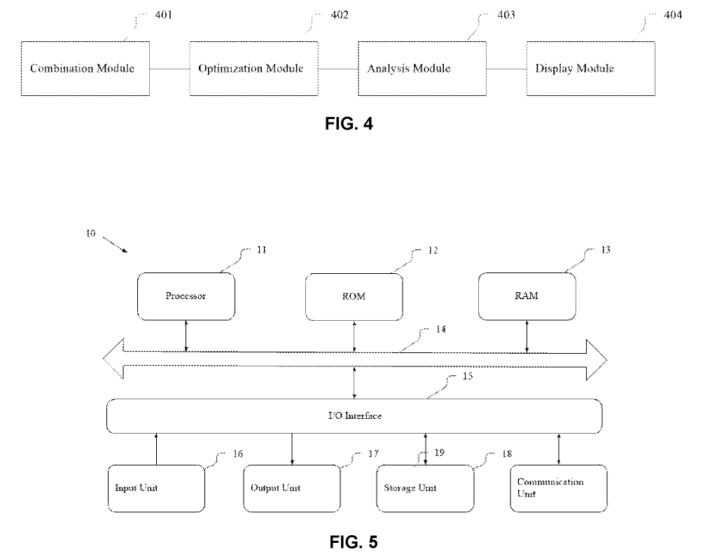

FIG. 4 is a schematic structural diagram of a design apparatus for a charging station provided in an embodiment of the present invention.

As shown in FIG. 4, the apparatus includes:

a combination module 41 configured to determine at least one parameter value for each design parameter item according to an allowable design range and each design parameter item of the charging station, and combine parameter values of each design parameter item to obtain at least one set of initial design data for the charging station, wherein each set of initial design data includes one parameter value for each design parameter item;

an optimization module 42 configured to perform search optimization on the at least one set of initial design data using design objectives of the charging station to obtain at least one set of target design data;

an analysis module 43 configured to input each set of target design data into a pre-trained performance analysis model for performance analysis to obtain an actual performance analysis result corresponding to each set of target design data, wherein the performance analysis model is a model with a training design data as an input sample and a training performance analysis result corresponding to the training design data as an output;

a display module 44 configured to generate and display a performance analysis report according to each set of target design data and the actual performance analysis result corresponding to each set of target design data, wherein the performance analysis report is used to guide a design strategy of the charging station.

Optionally, the combination module 41 is configured to:

determine a scanning strategy according to a preset parameter scanning type and a preset parameter distribution type; scan and combine the parameter values of each design parameter item according to the scanning strategy to obtain at least one set of initial design data for the charging station.

Optionally, the optimization module 42 is configured to:

input each set of initial design data into the performance analysis model for performance analysis to obtain an initial performance analysis result corresponding to each set of initial design data; determine an adaptability of each set of initial design data to the design objectives according to the design objectives of the charging station and the initial performance analysis result; perform a search on the initial design data using the adaptability of each set of initial design data to the design objectives to obtain an intermediate design data; swap part of the parameter values of identical design parameter items between any two intermediate design data to obtain the target design data.

Optionally, the apparatus further includes a model training module configured to train the performance analysis model. The model training module is configured to:

determine a charging demand of a sample charging station according to vehicle arrival information of the sample charging station, and simulate the training design data using the charging demand as a simulation requirement scenario to obtain a label performance analysis result corresponding to the training design data, wherein the training design data includes a training sample set and a validation sample set; train an original model using the training sample set and validate the original model using the validation sample set, wherein the original model is an artificial neural network with at least two hidden layers; take the original model as the performance analysis model if a difference between the training performance analysis result corresponding to the validation sample set output by the original model and the label performance analysis result is less than a preset threshold; and optimize model parameters of the original model if the difference between the training performance analysis result corresponding to the validation sample set output by the original model and the label performance analysis result is greater than or equal to the preset threshold.

Optionally, the model training module determining a charging demand of a sample charging station according to vehicle arrival information of the sample charging station includes:

determining vehicle arrival information of at least one vehicle according to historical vehicle charging information of the sample charging station; determining an average vehicle arrival rate of the sample charging station according to the vehicle arrival information of at least one vehicle, and determining the charging demand according to the average vehicle arrival rate.

Optionally, the model training module determining the charging demand according to the average vehicle arrival rate includes:

determining battery charging information corresponding to at least one vehicle according to the historical vehicle charging information; calculating waiting time information and charging time information for each vehicle using the battery charging information of each vehicle and the average vehicle arrival rate; calculating a load curve of the sample charging station using the waiting time information, charging time information, and average vehicle arrival rate of vehicles, and taking the load curve as the charging demand.

Optionally, the model training module calculating waiting time information and charging time information for each vehicle using the battery charging information of each vehicle and the average vehicle arrival rate includes:

determining an initial sorting sequence for each vehicle according to the average vehicle arrival rate and the vehicle arrival information of each vehicle; determining a charging demand weight of each vehicle according to the initial sorting sequence of each vehicle and the battery charging information corresponding to the vehicle; determining a final sorting sequence of each vehicle according to the charging demand weight of each vehicle, and calculating the waiting time information and charging time information of each vehicle according to the final sorting sequence of each vehicle.

The design apparatus for a charging station provided in the embodiment of the present invention can execute the design method for a charging station provided in any embodiment of the present invention and has corresponding functional modules for executing the method and beneficial effects.

FIG. 5 is a schematic structural diagram of an electronic device provided in an embodiment of the present invention. The electronic device 1 represents various forms of digital computers, such as laptop computers, desktop computers, workstations, personal digital assistants, servers, blade servers, mainframes, and other suitable computers. The electronic device may also represent various forms of mobile devices, such as personal digital processors, cellular phones, smart phones, wearable devices (e.g., helmets, glasses, watches, etc.), and other similar computing devices. The components, their connections and relationships, and their functions shown herein are merely examples, and are not intended to limit the implementation of the present invention described and/or claimed herein.

As shown in FIG. 5, the electronic device 1 includes at least one processor 11, and a memory in communication connection with the at least one processor 11, such as read-only memory (ROM) 12, random access memory (RAM) 13, etc., wherein the memory stores a computer program executable by the at least one processor. The processor 11 may execute various appropriate operations and processes according to the computer program stored in the read-only memory (ROM) 12 or the computer program loaded from a storage unit 18 into the random access memory (RAM) 13. In RAM 13, various programs and data required for the operation of the electronic device 1 may also be stored. The processor 11, ROM 12, and RAM 13 are connected to each other via a bus 14. An input/output (I/O) interface 15 is also connected to bus 14.

Multiple components in the electronic device 1 are connected to the I/O interface 15, including: an input unit 16, such as a keyboard, mouse, etc.; an output unit 17, such as various types of displays, speakers, etc.; the storage unit 18, such as a disk, optical disk, etc.; and a communication unit 19, such as a network card, modem, wireless communication transceiver, etc. The communication unit 19 allows the electronic device 1 to exchange information/data with other devices through computer networks such as the Internet and/or various telecommunication networks.

Processor 11 may be various general-purpose and/or special-purpose processing components having processing and computing capabilities. Some examples of the processor 11 include, but are not limited to, a central processing unit (CPU), a graphics processing unit (GPU), various dedicated artificial intelligence (AI) computing chips, various processors running machine learning model algorithms, a digital signal processor (DSP), and any suitable processor, controller, microcontroller, etc. The processor 11 executes the above-described methods and processes, such as the design method for a charging station.

In some embodiments, the design method for a charging station may be implemented as a computer program, which is tangibly included in a computer-readable storage medium, such as the storage unit 18. In some embodiments, part or all of the computer program may be loaded and/or installed onto the electronic device 1 via the ROM 12 and/or communication unit 19. When the computer program is loaded into the RAM 13 and executed by processor 11, one or more steps of the above-described design method for a charging station may be performed. Alternatively, in other embodiments, the processor 11 may be configured to perform the design method for a charging station in any other suitable manner (for example, by means of firmware).

The various embodiments of the systems and techniques described herein may be implemented in digital electronic circuit systems, integrated circuit systems, field-programmable gate arrays (FPGAs), application-specific integrated circuits (ASICs), application-specific standard products (ASSPs), system-on-chip systems (SOCs), complex programmable logic devices (CPLDs), computer hardware, firmware, software, and/or combinations thereof. These various embodiments may include implementations in one or more computer programs, which may be executed and/or interpreted on a programmable system including at least one programmable processor, which may be a special-purpose or general-purpose programmable processor, and which can receive data and instructions from, and transmit data and instructions to, a storage system, at least one input device, and at least one output device.

The computer program for implementing the method of the present invention may be written in any combination of one or more programming languages. These computer programs may be provided to a processor of a general-purpose computer, special-purpose computer, or other programmable data processing device, such that the computer programs, when executed by the processor, cause the functions/operations specified in the flowcharts and/or block diagrams to be implemented. The computer programs may be executed entirely on the machine, partly on the machine, partly on the machine and partly on a remote machine as a stand-alone software package, or entirely on the remote machine or server.

In the context of the present invention, the computer-readable storage medium may be a tangible medium that stores a computer program for use by or in connection with an instruction execution system, apparatus, or device. The computer-readable storage medium may include, but is not limited to, an electronic, magnetic, optical, electromagnetic, infrared, or semiconductor system, apparatus, or device, or any suitable combination of the foregoing. Alternatively, the computer-readable storage medium may be a machine-readable signal medium. More specific examples of the machine-readable storage medium would include an electrical connection based on one or more wires, a portable computer disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

To provide interaction with a user, the described systems and techniques may be implemented on an electronic device. The electronic device includes: a display device (for example, a CRT (cathode ray tube) or LCD (liquid crystal display) monitor) for displaying information to the user; and a keyboard and a pointing device (for example, a mouse or trackball) by which the user may provide input to the electronic device. Other kinds of devices may also be used to provide interaction with the user. For example, feedback provided to the user may be any form of sensory feedback (for example, visual feedback, auditory feedback, or tactile feedback), and input from the user may be received in any form (including acoustic input, speech input, or tactile input).

The systems and techniques described herein may be implemented in a computing system that includes a back-end component (for example, as a data server), or a middleware component (for example, an application server), or a front-end component (for example, a user computer having a graphical user interface or a Web browser through which a user may interact with an implementation of the systems and techniques described herein), or any combination of such back-end, middleware, or front-end components. The components of the system may be interconnected by any form or medium of digital data communication (for example, a communication network). Examples of communication networks include: a local area network (LAN), a wide area network (WAN), a blockchain network, and the Internet.

The computing system may include clients and servers. The clients and servers are generally remote from each other and typically interact through a communication network. The relationship of client and server arises by virtue of computer programs running on the respective computers and having a client-server relationship to each other. A server may be a cloud server, also known as a cloud computing server or cloud host, which is a host product in a cloud computing service system, designed to solve the shortcomings of traditional physical hosts and VPS services such as high management difficulty and weak business scalability.

It should be understood that various forms of the processes shown above can be used to reorder, add, or delete steps. For example, the steps described in the present application can be performed in parallel, sequentially, or in a different order, as long as the desired results of the technical solution of the present invention can be achieved. This is not limited herein.

The above specific embodiments do not constitute a limitation on the protection scope of the present invention. Those skilled in the art can understand that various modifications, combinations, sub-combinations, and substitutions can be made according to design requirements and other factors. Any modifications, equivalent replacements, and improvements made within the spirit and principle of the present invention shall fall within the protection scope of the present invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A design method for a charging station, comprising:
determining at least one parameter value for each design parameter item according to an allowable design range and each design parameter item of the charging station, and combining parameter values of each design parameter item to obtain at least one set of initial design data for the charging station, wherein each set of initial design data includes one parameter value for each design parameter item;
performing search optimization on the at least one set of initial design data using design objectives of the charging station to obtain at least one set of target design data;
inputting each set of target design data into a pre-trained performance analysis model for performance analysis to obtain an actual performance analysis result corresponding to each set of target design data, wherein the performance analysis model is a model with a training design data as an input sample and a training performance analysis result corresponding to the training design data as an output; and
generating and displaying a performance analysis report according to each set of target design data and the actual performance analysis result corresponding to each set of target design data, wherein the performance analysis report is used for guiding a design strategy of the charging station.

2. The design method for a charging station of claim 1, wherein the combining parameter values of each design parameter item to obtain at least one set of initial design data for the charging station comprises:
determining a scanning strategy according to a preset parameter scanning type and a preset parameter distribution type; and
scanning and combining the parameter values of each design parameter item according to the scanning strategy to obtain at least one set of the initial design data for the charging station.

3. The design method for a charging station of claim 1, wherein the performing search optimization on at least one set of initial design data using design objectives of the charging station to obtain at least one set of target design data comprises:
inputting each set of the initial design data into the performance analysis model for performance analysis to obtain an initial performance analysis result corresponding to each set of the initial design data;
determining an adaptability of each set of the initial design data to the design objectives according to the design objectives of the charging station and the initial performance analysis result;
performing a search in the initial design data using the adaptability of each set of the initial design data to the design objectives to obtain an intermediate design data; and
swapping part of the parameter values of identical design parameter items between any two intermediate design data to obtain the target design data.

4. The design method for a charging station of claim 1, wherein a process of training the performance analysis model comprises:
determining a charging demand of a sample charging station according to vehicle arrival information of the sample charging station, and simulating the training design data using the charging demand as a simulation requirement scenario to obtain a label performance analysis result corresponding to the training design data, wherein the training design data includes a training sample set and a validation sample set;
training an original model using the training sample set and validating the original model using the validation sample set, wherein the original model is an artificial neural network with at least two hidden layers;
taking the original model as the performance analysis model if a difference between the training performance analysis result corresponding to the validation sample set output by the original model and the label performance analysis result is less than a preset threshold; and
optimizing model parameters of the original model if the difference between the training performance analysis result corresponding to the validation sample set output by the original model and the label performance analysis result is greater than or equal to the preset threshold.

5. The design method for a charging station of claim 4, wherein the determining a charging demand of a sample charging station according to vehicle arrival information of the sample charging station comprises:
determining vehicle arrival information of at least one vehicle according to historical vehicle charging information of the sample charging station; and
determining an average vehicle arrival rate of the sample charging station according to the vehicle arrival information of at least one vehicle, and determining the charging demand according to the average vehicle arrival rate.

6. The design method for a charging station of claim 5, wherein the determining the charging demand according to the average vehicle arrival rate comprises:
determining battery charging information corresponding to at least one vehicle according to the historical vehicle charging information;
calculating waiting time information and charging time information for each vehicle using the battery charging information of each vehicle and the average vehicle arrival rate; and
calculating a load curve of the sample charging station using the waiting time information, charging time information, and average vehicle arrival rate of vehicles, and taking the load curve as the charging demand.

7. The design method for a charging station of claim 6, wherein the calculating waiting time information and charging time information for each vehicle using the battery charging information of each vehicle and the average vehicle arrival rate comprises:
determining an initial sorting sequence for each vehicle according to the average vehicle arrival rate and the vehicle arrival information of each vehicle;
determining a charging demand weight of each vehicle according to the initial sorting sequence of each vehicle and the battery charging information corresponding to the vehicle; and
determining a final sorting sequence of each vehicle according to the charging demand weight of each vehicle, and calculating the waiting time information and charging time information of each vehicle according to the final sorting sequence of each vehicle.

8. A design apparatus for a charging station, comprising:
a combination module configured to determine at least one parameter value for each design parameter item according to an allowable design range and each design parameter item of the charging station, and combine parameter values of each design parameter item to obtain at least one set of initial design data for the charging station, wherein each set of initial design data includes one parameter value for each design parameter item;
an optimization module configured to perform search optimization on the at least one set of initial design data using design objectives of the charging station to obtain at least one set of target design data;
an analysis module configured to input each set of target design data into a pre-trained performance analysis model for performance analysis to obtain an actual performance analysis result corresponding to each set of target design data, wherein the performance analysis model is a model with a training design data as an input sample and a training performance analysis result corresponding to the training design data as an output; and
a display module configured to generate and display a performance analysis report for guiding a design strategy of the charging station according to each set of target design data and the actual performance analysis result corresponding to each set of target design data.

9. An electronic device, comprising:
one or more processors; and
a memory configured to store one or more programs,
the one or more computer programs, when executed by the one or more processors, cause the one or more processor to implement the design method for a charging station of claim 1.

10. A computer-readable storage medium, which stores computer instructions, wherein the computer instructions, when executed by a processor, implement the design method for a charging station of claim 1.
